(19) United States
(12) Patent Application Publication
(10) Pub. No.: US 2009/0243541 A1
(43) Pub. Date: Oct. 1, 2009

(54) METHOD AND APPARATUS FOR RECHARGING BATTERY OF MOBILE STATION USING ELECTROMAGNETIC RESONANT WAVE

(75) Inventors: Taikyeong JEONG, Yongin-si (KR); Jabbar HAMID, Yongin-si (KR)

Correspondence Address: WESTMAN CHAMPLIN & KELLY, P.A., SUITE 1400, 900 SECOND AVENUE SOUTH, MINNEAPOLIS, MN, 55402, US

(73) Assignee: Myongji University Industry and Academia Cooperation Foundation, Yongin-si (KR)

(21) Appl. No.: 12/411,743

(22) Filed: Mar. 26, 2009

(30) Foreign Application Priority Data
Mar. 28, 2008 (KR) 10-2008-0028777

(51) Int. Cl. H02J 7/00

(52) U.S. Cl. 320/108

(57) ABSTRACT

A method and apparatus for recharging a battery of a mobile station are provided which can re-receive a signal emitted from an electromagnetic resonant circuit and automatically recharge the battery having the smallest remaining amount sequentially when a quantity of electric charges remaining in the battery is equal to or less than a reference value while the mobile station is utilizing a mobile communication service. The method includes the steps of: radiating the signal emitted from the electromagnetic resonant circuit; re-receiving the signal emitted from the electromagnetic resonant circuit; activating a conversion of power of the re-received signal; and charging the battery on the basis of a signal obtained by rectifying the re-received signal in accordance with the conversion of power.

### CROSS-REFERENCE TO RELATED APPLICATION(S)

The present application claims priority to Korean Patent Application No. 10-2008-0028777, filed on Mar. 28, 2008 in the Republic of Korea, and entitled “METHOD AND APPARATUS FOR RECHARGING BATTERY OF MOBILE STATION USING ELECTROMAGNETIC RESONANT WAVE”, the disclosure of which is incorporated by reference in its entirety.

### BACKGROUND

1. Field of the Invention

The present invention relates to method and apparatus for recharging a battery of a mobile station using an electromagnetic resonant circuit, and more particularly, to method and device for automatically recharging the battery having the smallest remaining amount sequentially in accordance with a response of a resonance response device to a signal emitted from an electromagnetic resonant circuit when a quantity of electric charges remaining in the battery is equal to or less than a reference value.

2. Related Art

Most wireless communication apparatuses can provide various mobile communication services using electromagnetic waves of various frequency bands radiated in air. For example, mobile communication/wireless Internet/radio broadcasting/TV broadcasting base stations or relays, portable Internet base stations or relays, artificial satellite, and the like in addition to portable terminals such as cellular phones use resonant wave of predetermined frequency bands allocated to services channels for services such as GSM, (W)CDMA, wireless Internet, radio broadcasting, TV broadcasting, WIBRO (portable Internet), DMB, and GPS.

However, since the electric charges or energy charged in a battery mounted on the portable terminals such as cellular phones is consumed within a predetermined time, for example, one or two days, depending on a service utilization time, the battery should be recharged for use. A user can recharge a battery by putting a mobile station on a charging holder or connecting a power converter connected to a power outlet to the mobile station by wire.

Accordingly, there is a need for a wireless battery recharging device allowing a user to always smoothly utilize wireless communication services without checking a remaining quantity of electric charges of a battery by automatically recharging the battery of the mobile station using signals radiated in a predetermined method, thereby removing a trouble of checking the quantity of electric charges remaining in the battery and recharging the battery.

### SUMMARY

An advantage of some aspects of the invention is to provide method and apparatus for recharging a battery using signals radiated in air in a predetermined method.

Another advantage of some aspects of the invention is to provide method and apparatus for recharging a battery of a mobile station, which can automatically recharge the battery having the smallest remaining amount sequentially using resonant circuits when a quantity of electric charges remaining in the battery is less than a reference value while the mobile station is utilizing mobile communication services.

According to an aspect of the invention, there is provided a wireless battery recharging method of allowing an electromagnetic resonant circuit to re-receive a signal, which is emitted from the electromagnetic resonant circuit using a battery, via a resonance response device and recharging the battery, the method including the steps of: determining a quantity of electric charges remaining in the battery; radiating the signal emitted from the electromagnetic resonant circuit; returning the radiated signal; re-receiving the signal; activating a conversion of power of the re-received signal; and charging the battery on the basis of a signal obtained by rectifying the re-received signal in accordance with the conversion of power.

The step of activating the conversion of power may include a sub-step of determining the conversion of power on the basis of the power of the re-received signal corresponding to a distance from the resonance response device.

The step of radiating the signal emitted from the electromagnetic resonant circuit may include a sub-step of radiating a battery remaining-quantity information, which is generated on the basis of information on the quantity of electric charges remaining in the battery, along with the emitted signal, and the step of charging the battery may include a sub-step of first charging a battery having a small quantity of electric charges remaining in the battery on the basis of the battery remaining-quantity information.

The step of charging the battery may include a sub-step of rectifying the re-received signal using a bridge diode.

The step of charging the battery may include the sub-steps: storing the rectified signal in a capacitor; regulating the voltage of the signal stored in the capacitor; and charging the battery using the regulated signal on the basis of the quantity of electric charges remaining in the battery.

When the battery is mounted on a mobile station utilizing a wireless communication service, the step of charging the battery may include repeating the sub-steps of: supporting a communication function while charging the battery when the quantity of electric charges remaining in the battery is equal to or less than a predetermined minimum value in the course of allowing the mobile station to support the communication function; and intercepting the charging of the battery when the quantity of electric charges remaining in the battery is equal to or greater than a predetermined maximum value.

The wireless battery recharging method may further include a step of intercepting the charging of the battery when the quantity of electric charges remaining in the battery is equal to or greater than a predetermined maximum value, after the step of charging the battery.

The wireless battery recharging method may further include a step of switching two output terminals of the battery to support a communication function of a mobile station when the battery is mounted on the communication station utilizing a wireless communication service, after the step of intercepting the charging of the battery.

A step of stopping supporting the communication function of the mobile station and charging the battery when the quantity of electric charges remaining in the battery is equal to or less than a predetermined minimum value and a step of intercepting the charging of the battery and switching two output terminals of the battery to support the communication function of the mobile station when the quantity of electric charges remaining in the battery reaches a predetermined maximum value may be repeated after the step of switching two output terminals.

According to another aspect of the invention, there is provided a wireless battery recharging device for allowing an electromagnetic resonant circuit to re-receive a signal, which is emitted from the electromagnetic resonant circuit using a battery, via a resonance response device and recharging the battery, the device including: an electromagnetic resonant circuit including a resistor, an inductor, and a capacitor; an antenna radiating the signal emitted from the electromagnetic resonant circuit to air; a control unit activating a conversion of power of the radiated signal re-received by the antenna; and a charging unit charging the battery on the basis of a signal obtained by rectifying the re-received signal in accordance with the conversion of power.

The charging unit may include: a bridge diode rectifying the re-received signal; a capacitor storing the output of the bridge diode; and a voltage regulator regulating the voltage of the signal stored in the capacitor. Here, the control unit may check a quantity of electric charges remaining in the battery and charges the battery using the output of the voltage regulator.

The control unit may intercept the charging of the battery when the quantity of electric charges remaining in the battery is equal to or greater than a predetermined maximum value.

When the wireless battery recharging device and the battery are mounted on a mobile station utilizing a wireless communication service, the control unit may intercept the charging of the battery and then switch two output terminals of the battery to support a communication function of the mobile station.

When the wireless battery recharging device and the battery are mounted on a mobile station utilizing a wireless communication service, the control unit may charge the battery while supporting a communication function when a quantity of electric charges remaining in the battery is equal to or less than a predetermined minimum value in the course of allowing the mobile station to support the communication function, and intercept the charging of the battery when the quantity of electric charges remaining in the battery is equal to or greater than a predetermined maximum value.

When the wireless battery recharging device and the battery are mounted on a mobile station utilizing a wireless communication service, the control unit may stop supporting a communication function of the mobile station and then charges the battery when a quantity of electric charges remaining in the battery is equal to or less than a predetermined minimum value, and intercept the charging of the battery and switches two output terminals of the battery to support the communication function of the mobile station when the quantity of electric charges remaining in the battery reaches a predetermined maximum value.

The wireless battery recharging device may include a plurality of wireless battery recharging devices, and the resonance response device may charge a plurality of batteries connected to the plurality of wireless battery recharging devices from the battery having the smallest quantity of electric charges remaining therein.

According to the above-mentioned aspects of the invention, since the battery is recharged using the electromagnetic resonant circuit, it is possible to provide the method and apparatus for recharging a battery of a mobile station using an electromagnetic resonant circuit, which can support a convenient battery recharging method without a trouble of the known wired battery recharging method using a power supply device connected to a power outlet.

According to the above-mentioned aspects of the invention, it is possible to provide the method and apparatus for recharging a battery of a mobile station using an electromagnetic resonant circuit, which can automatically recharge the battery up to a predetermined quantity of electric charges using the ambient resonant wave when a quantity of electric charges remaining in the battery is less than a reference value while the mobile station is utilizing mobile communication services, thereby removing the trouble of frequently recharging the battery of the mobile station at home or offices.

### BRIEF DESCRIPTION OF THE DRAWINGS

FIG. 1 is a diagram illustrating a signal source generator according to a first embodiment of the invention.

FIG. 2 is a diagram illustrating a wireless battery recharging device according to the first embodiment of the invention.

FIG. 3 is a diagram more specifically illustrating a power converter shown in FIG. 2.

FIGS. 4 and 5 are circuit diagrams illustrating an electromagnetic resonant circuit according to the first embodiment of the invention.

FIG. 6 is a diagram illustrating a wireless battery recharging system according to a second embodiment of the invention.

FIG. 7 is a flow diagram illustrating a flow of operations of the wireless battery recharging devices according to the first embodiments of the invention.

FIG. 8 is a diagram illustrating charging and discharging states of a battery according to the first embodiment of the invention.

FIG. 9 is a flow diagram illustrating a flow of operations of the wireless battery recharging devices according to the second embodiments of the invention.

FIG. 10 is an additional diagram illustrating a wireless battery recharging device according to the first embodiment of the invention.

### DESCRIPTION OF EXEMPLARY EMBODIMENTS

Hereinafter, exemplary embodiments of the invention will be described in detail with reference to the accompanying drawings, but the invention is not limited to the exemplary embodiments. Like reference numerals in the drawings reference like elements.

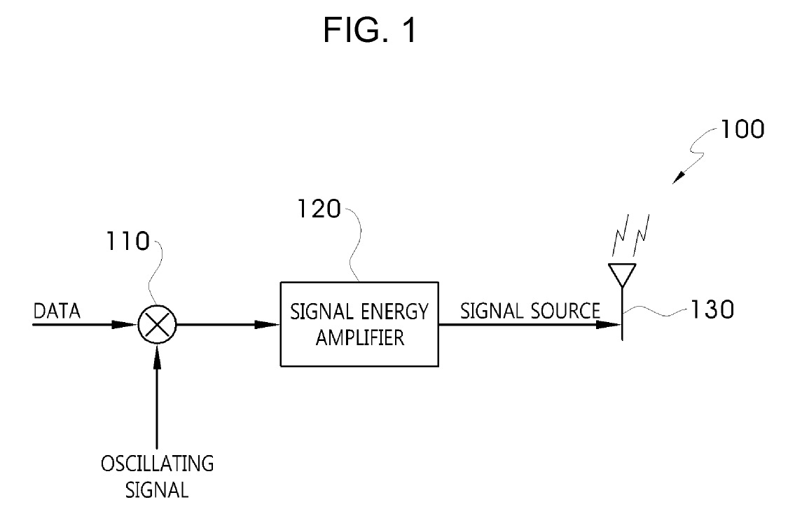

FIG. 1 is a diagram illustrating a signal source generator 100 according to a first embodiment of the invention.

A signal source used to wireless charge a battery according to the first embodiment of the invention may be an resonant wave radiated the signal source generator 100 connected to a battery. The signal radiated from the signal source generator 100 may be a signal of any frequency band radiated with power sufficient to charge a battery.

For example, the signal source generator 100 synthesizes a data stream for the corresponding service with oscillation signals of a predetermined band, that is, carrier waves, by the use of a frequency synthesizer 110, amplifies the corresponding signals by the use of a signal energy amplifier 120, and radiates the amplified signals in air through an antenna 130. At this time, a signal required for oscillation can be generated using an electromagnetic resonant circuit (not shown). The signal energy amplifier 120 may be a power amplifier type and can radiate a resonant wave with sufficient power to satisfactorily charge a battery by the use of a signal via peripheral devices of the signal source generator 100, that is, a resonance response device disposed in an access point. For example, the resonant wave can be radiated with power of about 1 to 5 watt at a band of 800 to 2300 MHz.

In this embodiment, it is possible to conveniently recharge the battery mounted on a mobile station by re-receiving the resonant wave radiated from the electromagnetic resonant circuit using the power of the battery without using a wired charging device connected to a power outlet.

A wireless battery recharging device according to the first embodiment of the invention in which a principle of the signal source generator according to the first embodiment of the invention is applied to a mobile station will be described with reference to the accompanying drawings. The overlapping details with the signal source generator according to the first embodiment of the invention will be omitted or be described in brief.

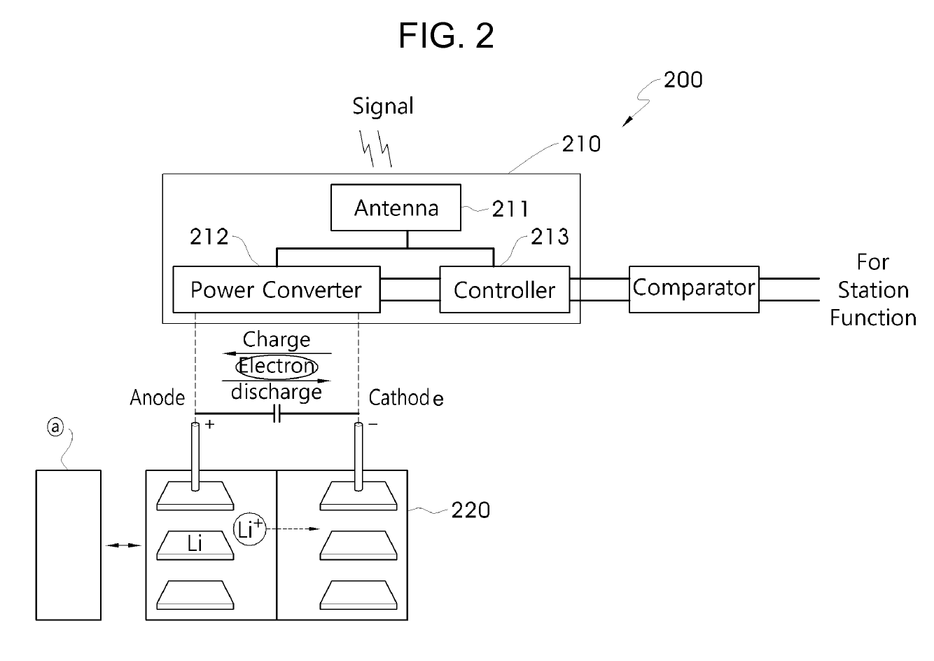

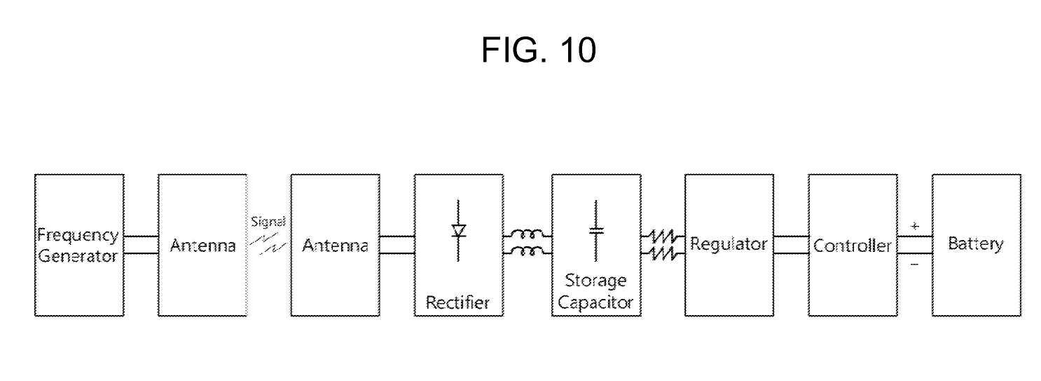

FIGS. 2 and 10 are diagrams illustrating a wireless battery recharging device 200 according to the first embodiment of the invention.

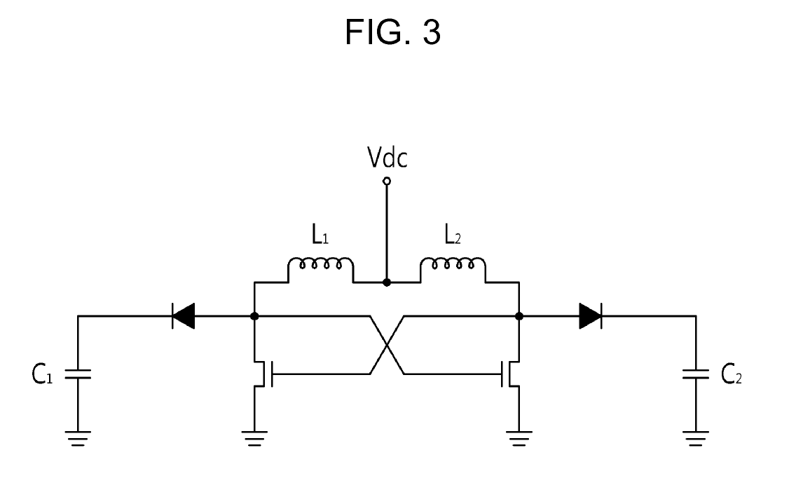

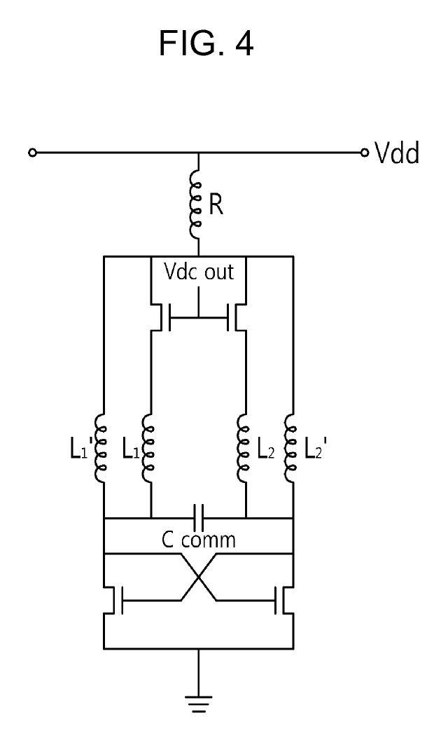

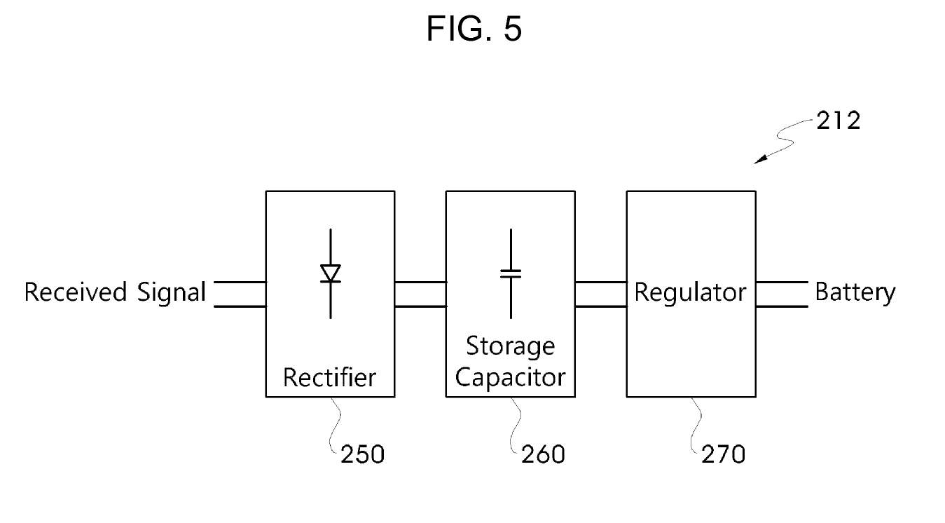

Referring to FIGS. 2 and 10, the wireless battery recharging device 200 according to the first embodiment of the invention charges a battery 220 by the use of a charging device 210. The charging device 210 includes an antenna 211, a power converter 212, and a controller 213. The power converter 212 as the charging unit can be embodied by combination of active elements and passive elements. The power converter 212 may be an electromagnetic resonant circuit including a resistor, an inductor, and a capacitor, or may include a rectifier 250, an inductor, a storage capacitor 260, a resistor, and a voltage regulator 270 as shown in FIG. 3. The electromagnetic resonant circuit can be embodied as shown in FIGS. 4 and 5. The electromagnetic resonant circuit may be included in a circuit built in the battery 220 or may be embodied as an independent circuit and be connected to the battery 220(\textcircled{a}) as shown in FIG. 2.

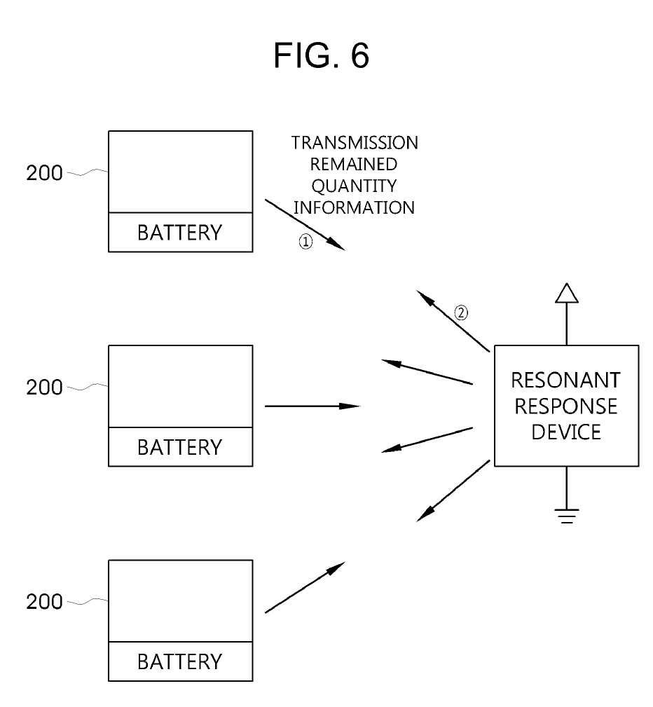

FIG. 6 is a diagram illustrating a wireless battery recharging system 600 according to a second embodiment of the invention.

Referring to FIG. 6, the wireless battery recharging system 600 according to the second embodiment of the invention includes a resonance response device and plural wireless battery recharging devices 200. Here, the plural wireless battery recharging devices 200 are connected to plural batteries, respectively, and are the same as the wireless battery recharging device according to the first embodiment of the invention.

The respective battery recharging devices 200 emit signals using the electromagnetic resonant circuit and transmit the signal to the resonance response device via an antenna of a mobile station. Here, battery remaining-quantity information including information on the quantity of electric charges remaining in the batteries are generated and transmitted along with the signals. The resonance response device can compare the quantities of electric charges remaining the batteries connected to the wireless battery recharging devices 200, respectively, by the use of the battery remaining-quantity information. The resonance response device compares the battery remaining-quantity information with each other and allows the battery having the smallest quantity of electric charges remaining therein among the batteries to be first charged.

That is, the resonance response device charges one battery by returning the signal transmitted from one wireless battery recharging device connected to the battery to the corresponding wireless battery recharging device again. At this time, when a different battery having the smaller quantity of electric charges than the battery exists in the vicinity of the resonance response device, the charging of the battery is stopped and the different battery can be charged.

As described above, the wireless battery recharging system according to this embodiment can compare the quantities of electric charges remaining in the batteries and can first charge the battery necessary most requiring the charging.

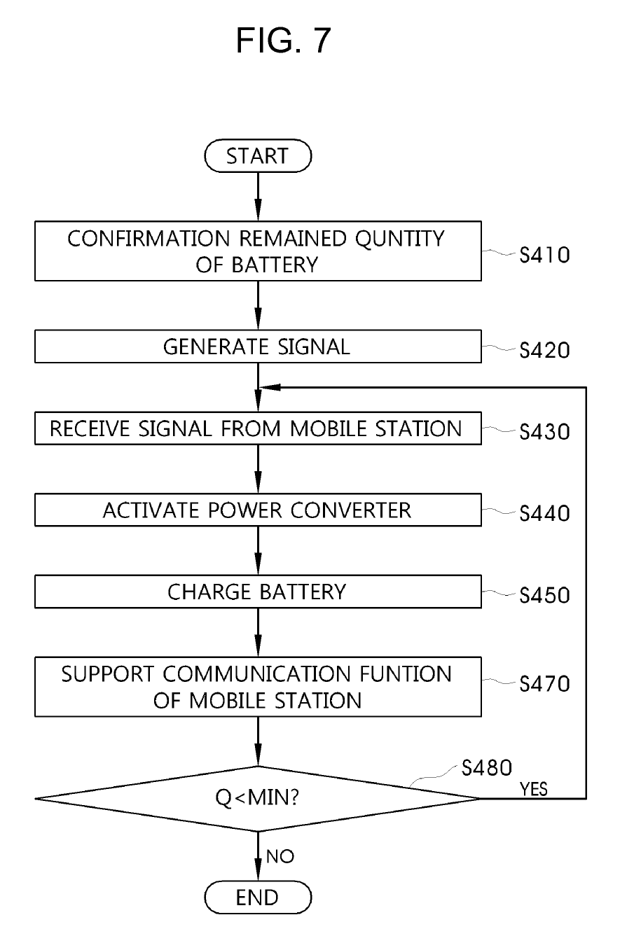

The operations of the wireless battery recharging device 200 shown in FIGS. 2 and 4 will be described with reference to the flow diagram shown in FIG. 7.

First, the controller 213 as a control unit checks whether the quantity of electric charges remaining in the battery is less than a predetermined level, before performing the charging (S410 in FIG. 7). That is, since a charging device 210 should radiate a signal to the resonance response device (not shown) using the power of the battery, the controller 213 generates the signal when the quantity of electric charges less than a predetermined level remains in the battery 220 before the battery 220 is completely discharged.

When the charging device 210 radiates the signal (S420 in FIG. 7), the resonance response device returns the signal to the charging device 210. The antenna 211 of the wireless battery recharging device 200 apart from the resonance response device by a predetermined distance receives the signal radiated from the resonance response device (S430 in FIG. 7). The wireless battery recharging device 200 according to the first embodiment of the invention radiates the signal generated by the electromagnetic resonant circuit to the resonance response device, re-receives the signal radiated in air from the resonance response device, and uses the re-received signal to charge the battery 220. Here, the wireless battery recharging device 200 may be an exclusive device independent of a mobile station or may be a partial device mounted on the mobile station along with the battery 220.

Here, examples of the mobile station can include all terminals capable of utilizing various wireless communication services, such as a PCS (Personal Communications Services) phone, a synchronous/asynchronous IMT-2000 (International Mobile Telecommunication-2000), palm PC (Personal Computer), a PDA (Personal Digital Assistant), a smart phone, WAP (Wireless Application Protocol) phone, and a mobile play-station.

After receiving the signal, the controller 213 can activate a conversion of power (S440 in FIG. 7). The activation of the conversion of power for activating the power converter 212 can be determined on the basis of the power of the received signal. For example, when the wireless battery recharging device 200 is located within a predetermined distance of, for example, 2 to 5 meters from the signal source generator 100, it can be determined that the power is sufficient to charge the batter 220 and the activation of the conversion of power can be determined. Otherwise, the activation of the conversion of power may not be determined.

When the activation of the conversion of power is determined, the power converter 212 operates to charge the battery 220 on the basis of the signal obtained by rectifying the received signal (S450 in FIG. 7). The rectifier 250 of the power converter 212 rectifies the received signal into a DC signal. The rectifier 250 may be a bridge diode type including four diodes or may be another circuit rectifying AC into DC.

The storage capacitor 260 stores the DC output of the bridge diode. The voltage regulator 270 regulates the voltage of the DC signal stored in the storage capacitor 260 to be kept a predetermined voltage. The voltage regulator 270 may include active elements such as a diode and a transistor or passive elements such as a resistor and a capacitor. The storage capacitor 260 and the voltage regulator 270 serve to stably maintain a predetermined output voltage in spite of noises.

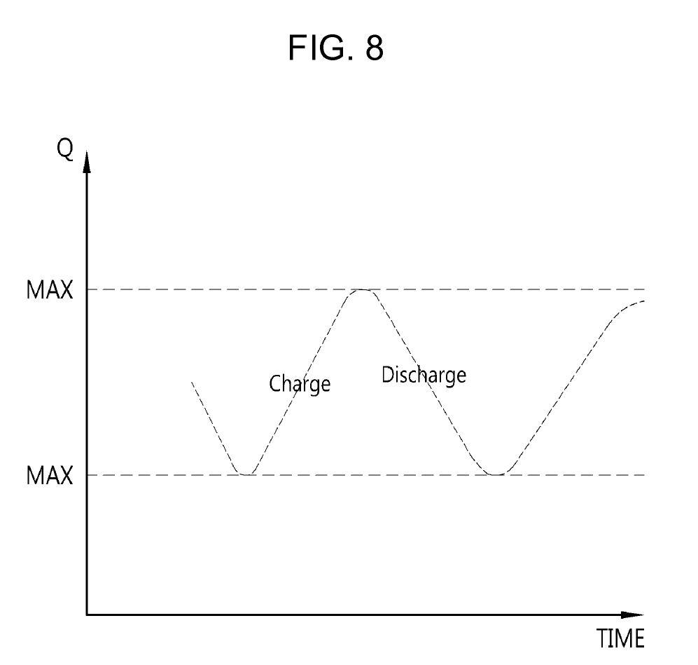

The controller 213 checks a quantity of electric charges remaining in the battery 220 and controls the power controller 212 to charge the battery 220 using the output of the voltage regulator 270 in accordance with the check result. When the wireless battery recharging device 200 is an exclusive device dedicated to a holder and separated from the mobile station, the controller 213 can always charge the battery 220 using the output of the voltage regulator 270 every time of connection to the battery 220. When the charging advances and the quantity of electric charges remaining in the battery 220 is greater than a predetermined maximum value (see MAX in FIG. 8), the controller 213 can intercept the charging of the battery 220.

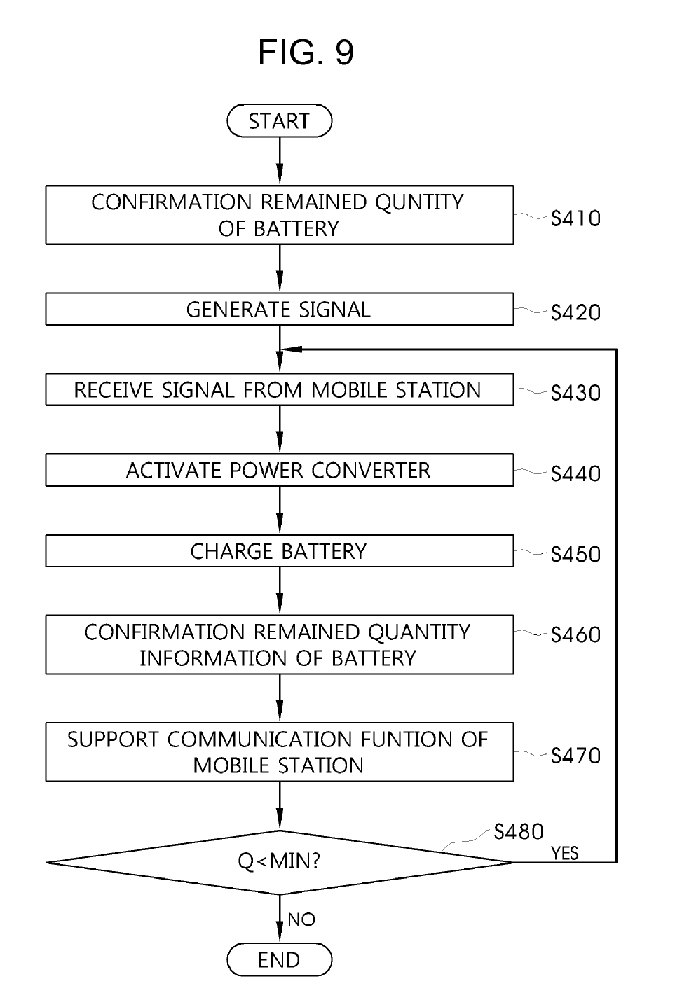

When the plural wireless battery recharging devices 200 are provided as in the second embodiment, the resonance response device compares the batter remaining-quantity information of the batteries connected to the wireless battery recharging devices, respectively, and allows the battery having the smallest quantity of electric charges to be first charged as shown in FIG. 9 (S460).

For example, when the wireless battery recharging device 200 and the battery 220 are mounted on a mobile station utilizing wireless communication services and the quantity of electric charges remaining in the battery 220 is greater than a predetermined maximum value (see MAX in FIG. 8), the controller 213 intercepts the charging of the battery 220 and switches two output terminals (anode and cathode) of the battery 220 so as to support the communication function of the mobile station by the use of a predetermined switch (S470 in FIG. 7). That is, when the wireless battery recharging device 200 and the battery 220 are mounted on a mobile station utilizing a wireless communication service and the quantity of electric charges remaining in the battery 220 is less than a predetermined minimum value (see MIN in FIG. 8), the controller 213 can intercept the supporting of the communication function of the mobile station and charge the battery 220 by performing the processes of step S420 and steps subsequent thereto again. When the charging advances and the quantity of electric charges remaining in the battery 220 is greater than the predetermined maximum value (see MAX in FIG. 8), the controller can repeat the processes of intercepting the charging of the battery 220 and switching two output terminals of the battery 220 to support the communication function of the mobile station (S480 in FIG. 7).

As shown in FIG. 2, the battery 220 may be a secondary battery using an electrode plate of lithium (Li) or the like. At the time of charging, electrons migrates from a cathode to an anode of the battery 220 by the power converter 212 to increase the quantity of electric charges (Q) remaining in the battery 220. When a load is applied to the battery 220 for the communication function of the mobile station, the electrons migrate in the opposite direction to discharge electricity, thereby decreasing the remaining quantity of electric charges (Q).

On the other hand, when the wireless battery recharging device 200 and the battery 220 are mounted on a mobile station utilizing a wireless communication service and the quantity of electric charges remaining in the battery 220 is less than a predetermined minimum value (see MIN in FIG. 8) while the mobile station is supporting the communication function under the control of the controller 213, the controller 213 can charge the battery 220 at the same time as supporting the communication function. When the charging advances and the quantity of electric charges remaining in the battery 220 is greater than a predetermined maximum value, the controller 213 can intercept the charging of the battery 220. By repeating these processes, it is possible to continuously support the communication function of the mobile station without interception.

According to the embodiments, by automatically recharging the battery 220 up to a predetermined quantity of electric charges when the quantity of electric charges remaining in the battery 220 is less than a reference value while the mobile station is utilizing a mobile communication service, it is possible to allow a user to utilize a communication service by the use of the battery 220 always charged without a trouble of frequently recharging the battery 220 of the mobile station at home or in offices.

Although the invention has been described with reference to the exemplary embodiments and the drawings, the invention is not limited to the embodiments. It will be understood by those skilled in the art that the invention can be modified in various forms. Accordingly, the scope of the invention is not limited to the embodiments, but should be determined by the appended claims and equivalents thereof.

1. A battery recharging method of allowing an electromagnetic resonant circuit to re-receive a signal, which is emitted from the electromagnetic resonant circuit using a battery, via a resonance response device and recharging the battery, the method comprising the steps of:
determining a quantity of electric charges remaining in the battery;
radiating the signal emitted from the electromagnetic resonant circuit;
returning the radiated signal;
re-receiving the signal;
activating a conversion of power of the re-received signal; and
charging the battery on the basis of a signal obtained by rectifying the re-received signal in accordance with the conversion of power.

2. The battery recharging method according to claim 1, wherein the step of activating the conversion of power includes a sub-step of determining the conversion of power on the basis of the power of the re-received signal corresponding to a distance from the resonance response device.

3. The battery recharging method according to claim 1, wherein:
the step of radiating the signal emitted from the electromagnetic resonant circuit includes a sub-step of radiating a battery remaining-quantity information, which is generated on the basis of information on the quantity of electric charges remaining in the battery, along with the emitted signal; and
the step of charging the battery includes a sub-step of first charging a battery having a small quantity of electric charges remaining in the battery on the basis of the battery remaining-quantity information.

4. The battery recharging method according to claim 1, wherein the step of charging the battery includes a sub-step of rectifying the re-received signal using a bridge diode.

5. The battery recharging method according to claim 1, wherein the step of charging the battery includes the sub-steps:
storing the rectified signal in a capacitor;
regulating the voltage of the signal stored in the capacitor; and
charging the battery using the regulated signal on the basis of the quantity of electric charges remaining in the battery.

6. The battery recharging method according to claim 1, wherein when the battery is mounted on a mobile station utilizing a wireless communication service, the step of charging the battery includes repeating the sub-steps of:
supporting a communication function while charging the battery when the quantity of electric charges remaining in the battery is equal to or less than the minimum value in the course of allowing the mobile station to support the communication function; and
intercepting the charging of the battery when the quantity of electric charges remaining in the battery is equal to or greater than the maximum value.

7. The battery recharging method according to claim 1, further comprising a step of intercepting the charging of the battery when the quantity of electric charges remaining in the battery is equal to or greater than the maximum value, after the step of charging the battery.

8. The battery recharging method according to claim 7, further comprising a step of switching two output terminals of the battery to support a communication function of a mobile station when the battery is mounted on the communication station utilizing a wireless communication service, after the step of intercepting the charging of the battery.

9. The battery recharging method according to claim 8, wherein a step of stopping supporting the communication function of the mobile station and charging the battery when the quantity of electric charges remaining in the battery is equal to or less than the minimum value and a step of intercepting the charging of the battery and switching two output terminals of the battery to support the communication function of the mobile station when the quantity of electric charges remaining in the battery reaches the maximum value are repeated after the step of switching two output terminals.

10. A battery recharging apparatus for allowing an electromagnetic resonant circuit to re-receive a signal, which is emitted from the electromagnetic resonant circuit using a battery, via a resonance response device and recharging the battery, the device comprising:
an electromagnetic resonant circuit including a resistor, an inductor, and a capacitor;
an antenna radiating the signal emitted from the electromagnetic resonant circuit to air;
a control unit activating a conversion of power of the radiated signal re-received by the antenna; and
a charging unit charging the battery on the basis of a signal obtained by rectifying the re-received signal in accordance with the conversion of power.

11. The battery recharging apparatus according to claim 10, wherein the charging unit includes:
a bridge diode rectifying the re-received signal;
a capacitor storing the output of the bridge diode; and
a voltage regulator regulating the voltage of the signal stored in the capacitor, and
wherein the control unit determines a quantity of electric charges remaining in the battery and charges the battery using the output of the voltage regulator.

12. The battery recharging apparatus according to claim 10, wherein the control unit intercepts the charging of the battery when the quantity of electric charges remaining in the battery is equal to or greater than the maximum value.

13. The battery recharging apparatus according to claim 12, wherein when the wireless battery recharging device and the battery are mounted on a mobile station utilizing a wireless communication service, the control unit intercepts the charging of the battery and then switches two output terminals of the battery to support a communication function of the mobile station.

14. The battery recharging apparatus according to claim 10, wherein when the wireless battery recharging device and the battery are mounted on a mobile station utilizing a wireless communication service, the control unit:
charges the battery while supporting a communication function when a quantity of electric charges remaining in the battery is equal to or less than the minimum value in the course of allowing the mobile station to support the communication function; and
intercepts the charging of the battery when the quantity of electric charges remaining in the battery is equal to or greater than the maximum value.

15. The battery recharging apparatus according to claim 10, wherein when the wireless battery recharging device and the battery are mounted on a mobile station utilizing a wireless communication service, the control unit:
stops supporting a communication function of the mobile station and then charges the battery when a quantity of electric charges remaining in the battery is equal to or less than the minimum value, and
intercepts the charging of the battery and switches two output terminals of the battery to support the communication function of the mobile station when the quantity of electric charges remaining in the battery reaches the maximum value.

16. The battery recharging apparatus according to claim 10, wherein the wireless battery recharging device includes a plurality of wireless battery recharging devices, and wherein the resonance response device charges a plurality of batteries connected to the plurality of wireless battery recharging devices from the battery having the smallest quantity of electric charges remaining therein.
